(19) United States
(12) Patent Application Publication
(10) Pub. No.: US 2013/0245840 A1
(43) Pub. Date: Sep. 19, 2013

(54) Modulated Reset Relief Valve

(71) Applicant: Gerard S. Lazzara, Houston, TX (US)

(72) Inventor: Gerard S. Lazzara, Houston, TX (US)

(21) Appl. No.: 13/421,965

(22) Filed: Mar. 16, 2012

(51) Int. Cl. G05D 7/00

(52) U.S. Cl. 700/282

(57) ABSTRACT

A reset relief valve with a body having an inlet port, an outlet port, and piston defining an enclosed chamber, where the piston is disposed in the body and moveable between a first position at which the piston is disposed in fluid flow-blocking relationship between the inlet port and the outlet port of the body and a second position at which the piston is removed from that position, an electrically motivated worm drive operably connected to the piston. for controlled smooth movement of the piston responsive to pressure readings in the system. A preferred embodiment includes data acquisition software for monitoring data and storing pressure and other data to control the operation of the valve and a handheld controller.

### CROSS REFERENCE TO RELATED APPLICATIONS

None

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of pressure relief valves and more specifically to a modulated reset relief valve.

Pressure relief valves are important components in certain fluid flow systems in which undesirable high pressure may occur. In such systems, overpressure can damage valuable processing equipment or cause breakdown or rupture of weak components of the system. It is desirable that when a pre-determined or pre-designated threshold pressure is exceeded, the pressure relief valve open very quickly, i.e., virtually instantaneously, to relieve system pressure. Pressure relief valves having this capability are commonly referred to as “pop-off” valves because of their rapid opening action. In carrying out the rapid opening of the valve, these valves have essentially two positions: the port-blocking position and an open position. There is no ability to control the opening of the valve and immediately close the valve. Rather, upon activation all pressure is released and the system has to be reset placing the equipment in a downtime phase costing valuable time.

Prior art patents U.S. Pat. No. 7,117,885 and U.S. Pat. No. 7,311,117 to Lazzara et al. shows a reset relief valve that has an internal piston and disc configuration that greatly reduces impact forces upon activation of the valve. But like other prior art solutions, none of these valves may be opened and closed in a controlled and smooth fashion. Rather, upon reaching a pre-determined pressure level, the valve becomes fully open and stays in the open position until manually reset. Nothing in the prior art shows a computer integrated pressure sensing modulated reset valve that can be actively controlled as shown in the present invention.

### BRIEF SUMMARY OF THE INVENTION

The primary advantage of the invention is to provide a pressure relief valve that is modulated and controlled during operation.

Another advantage of the invention is to provide a relief valve that utilizes a transducer in line with the ambient pressure to permit partial opening of the valve in fine increments.

Another advantage of the invention is to provide a relief valve that transmits data to a computer for later analysis of important operating characteristics.

A further advantage of the invention is to provide a relief valve that can be controlled during its operation to prevent certain damaging events to the valve or underlying pressurized system.

Yet another advantage of the invention is to provide an improved actuator and valve assembly for monitoring pressure and impact forces during operation.

Other advantages of the present invention will become apparent from the following descriptions, taken in connection with the accompanying drawings, wherein, by way of illustration and example, an embodiment of the present invention is disclosed.

In accordance with a preferred embodiment of the invention, there is shown a modulated reset relief valve having a body with an inlet port, an outlet port, and a piston, the piston disposed in the body and moveable between a first position at which the piston is disposed in fluid flow-blocking relationship between the inlet port and the outlet port of the body thereby defining a pressurized chamber and a second position at which the piston is removed from the fluid flow-blocking position, the piston having a stem that is operably engaged to an electrically controlled actuator, a pressure sensor in fluid communication with the chamber for sensing pressure, and control of the piston through the sensed parameter for opening and closing the valve by activation of the actuator.

In accordance with a preferred embodiment of the invention, there is shown a modulated reset relief valve having, a body having an inlet port, an outlet port, and a piston, the piston disposed in the body and moveable between a first position at which the piston is disposed in fluid flow-blocking relationship between the inlet port and the outlet port of the body thereby defining a pressurized chamber and a second position at which the piston is removed from the fluid flow-blocking position, a pressure sensor in fluid communication with the chamber for sensing pressure that is electronically connected to worm drive, the piston selectively moveable between the first position and the second position responsive to movement of the drive.

In accordance with a preferred embodiment of the invention, there is shown a modulated reset relief valve having a body having an inlet port, an outlet port, and a piston, the piston disposed in the body and moveable between a first position at which the piston is disposed in fluid flow-blocking relationship between the inlet port and the outlet port of the body thereby defining a pressurized chamber and a second position at which the piston is removed from the fluid flow-blocking position, the piston sealably engages a cylindrical member positioned above the inlet port in the body when in the first position, where the member has an inner diameter substantially equal to the outer diameter of the piston, a transducer for sensing fluid pressure on the piston electrically connected to a computer for storing and analyzing pressure data from operation of the valve, an electrically activatable worm drive operably connected to the piston for reversible movement of the piston.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a side cross sectional view of a preferred embodiment of a modulated reset valve set in an open position.

FIG. 2 is a side cross sectional view of a modulated reset valve and computer controlled actuator set in the open or activated position.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

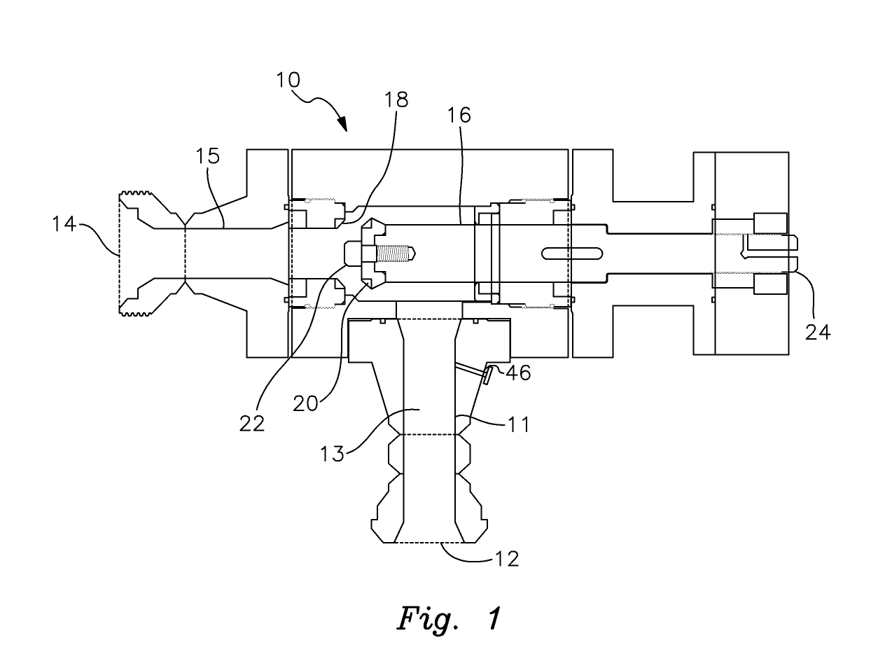

Turning now to FIG. 1, there is shown a reset valve 10 having an inlet port 12 that is adapted to receive the line conduit 11, and an internally disposed annular chamber 13 in fluid communication with an outlet port 15 that is adapted to receive the discharge conduit 14. Valve 10 has an internal bore providing an interior cylindrical seating surface 18 that engages piston cap 20 of piston 16, the features and function of which are disclosed below in more detail. Piston 16 has at its upper portion piston cap 20 attached with cap screw 22. This permits removability and replacement of piston cap 20 due to wear or deformation.

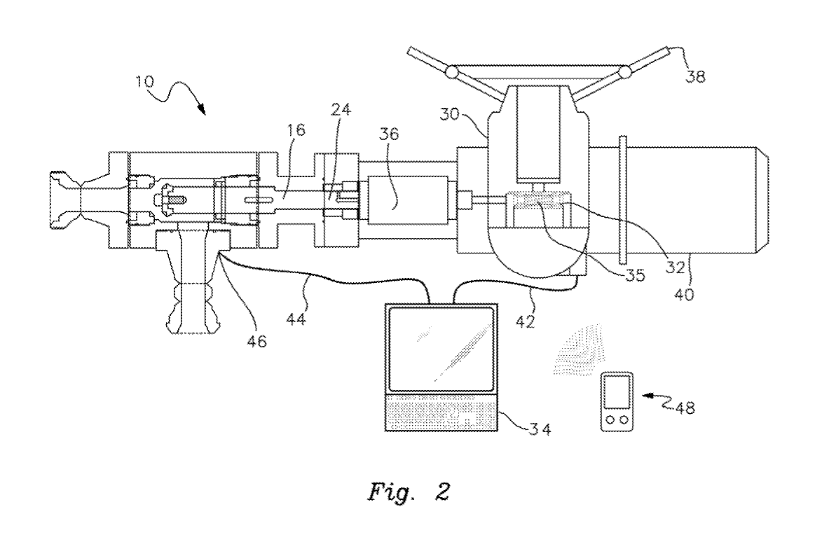

Piston 16 is operably connected to an actuator via stem 24 and is controlled by pressure readings as more fully described with respect to FIG. 2. As piston 16 is engaged and piston cap 20 is moved toward seating surface 18, flow from inlet port 12 to discharge conduit 14 is reduced. Upon full engagement of piston cap 20 to seating surface 18, flow is completely cut off. As is readily apparent, as pressure in the system builds in annular chamber 13, pressure probe 46 is capable of monitoring that pressure which in turn is used to activate the controlled movement of piston 16 from closed to partially open or fully open positions and all stages in between. This permits a reduction in pressure and responses to pressure spikes in the system to avoid a catastrophic event that ultimately would cause a total shutdown of the pumping system.

Turning now to FIG. 2, there is shown a side cross sectional view of a modulated reset valve and computer controlled actuator set in the open or activated position. Actuator 30 is operably connected to piston 16 through stem 24 to rod 36 which is operably engaged to a worm drive 32 for controlled movement of rod 36. Rod 36 is operably engaged to worm screw 35 which is matably engaged to worm drive 32. Upon receiving computer signals from computer 34 via link 42, worm drive 32 is electrically actuated to turn in one direction or the other as required. This movement in turns controls the movement of piston 16 and its position as closed or open. Link 44 is connected to pressure probe 46 that monitors the pressure on annular chamber 13. As the pressure rises, analysis of the pressure in the computer processor determines if the valve should be partially opened or fully opened. In some cases, a pressure spike will be sensed which will cause the computer to send a signal to the actuator to quickly open the valve for a short period of time and then close the valve to maintain operation of the pumping system. The pressure probe or transducer may be placed in a self contained oil chamber not exposed to corrosive or erosive muds and other liquids.

When a pressure setting is exceeded, the valve modulates to allow excess pressure to bleed off until a second pre-determined pressure is achieved and then resets automatically. Worm drive 32 is operable in such a way as to move the piston 16 over a range of positions to permit varying bleed rates of the valve. If the valve senses a spike in pressure, worm drive 32 may open the valve by rotating which in turn moves piston 16 away from seating surface 18. As pressure returns to a pre-determined level, worm drive 32 rotates the opposite direction and engages piston 16 with seating surface 18 to close the valve.

In other situations, a small pressure rise may necessitate a controlled movement of the piston to open the valve followed by a slow closing of the valve to restore a closed position. In other settings, the valve can be opened for pre-determined periods of time and then closed or partially closed depending on the user's preferences.

The modulated valve of the present invention is preferably electrically powered thus removing the need for air pressure or hydraulic motivation. It may be outfitted with a DC power supply, preferably a 24 volt power supply that can be activated to open the valve to a failsafe position in the event of a loss of AC power. Housing 40 may contain various electrical circuit boards for control of the actuator and inputs for electrical supply not shown. It may also contain battery backup or battery back up may be maintained in another housing electrically connected to actuator 30. By using an electrically controlled actuator, the valve can preferably be configured to trip from 0 to 15,000 PSI to within 1 PSI increments, thus having a wide dynamic range. One advantage of this type of controlled system is that the valve can operate like a choke to limit pressure without fully relieving all the pressure.

FIG. 2 shows hand crank 38, which preferably is a direct drive handwheel (or geared handwheel on larger sizes) that provides reliable emergency manual operation in the event of a power supply failure. Hand crank 38 may include a padlockable hand/auto clutch for safe operation even when the motor is running.

Computer 32 is operably connected to actuator 30 and worm drive 32 through link 42 and is in turn connected through link 44 to pressure probe 46. With a touch screen operation or keyboard control, the user can set trip set-points, resets, an auto reset timer, manual trip cycle counts, alarms and maintain in the storage of the computer historical data logged on the system.

The actuator 30 may also be outfitted with wireless control 48 using it as a point and shoot hand held remote. Communication between wireless control 48 and the actuator may be through infra-red or other known wireless communications links. Wireless control 48 may also be interconnected to computer 34 to control actuator 30 and reset valve 10. The computer enables the system to be connected to a network and permits a central control to operate a plurality of valves. This also permits the user to tie into the rig control network for further monitoring and control.

The actuator system allows eight helps screens (multilingual) that can be set with the setting tool allowing real time, grouped analysis of control signal status, valve and actuator status. Software is preferably a graphical user interface allowing all set-up configuration and data logger information to be reviewed, analyzed and reconfigured.

Separately sealed terminal compartment or housing 40 ensures the integrity of the electrical equipment even when the terminal cover is removed during on-site wiring.

In alternative embodiments other sensors may be employed in conjunction with or instead of the pressure sensor such as temperature sensors, viscosity sensors or other parameters of interest to the user that are interconnected in a similar manner to measure ambient features of the oil filled chamber. By connecting such data in a real time system to a computer controlled system, the valve and mud pump may be operably controlled based on any of a variety of pre-determined criteria.

By storing data on a recurring basis, the operator can design the system with greater degrees of control and can analyze the data associated with an activation of the valve to better utilize the valve and other pumps in the system. Other ports are positioned around the pressure sensor assembly for insertion of oil or other hydraulic fluid.

Software may be developed for the valve including a method of acquiring multiple streams of analog data as real time occurrences and simultaneously displaying and storing them via digital interface using an interface system for later analysis. Using such software, the control computer can can monitor and record, in a preferred embodiment, from 1 to 4 simultaneous analog pressure readings at a rate of 1 sample/sec per channel or faster. In addition a secondary capacity to monitor 4 digital only inputs may be utilized in the current system, with desired inputs.

The software should be a data acquisition and storage system, preferably, with a 90 day continuous storage capacity. The computer software permits real time evaluation of ambient pressure in the system and control of the valve according to the user's preferences. Due to the recurrent sensing of data, the user may analyze the date to determine the cause of the pressure spike that may have set off the valve.

In an illustrative example, the reset valve 10 is installed in a system for pumping drilling mud composed of water, clay and chemical additives, down through the inside of a drill pipe of an oil well drilling operation. The drilling mud is pumped at very high pressure, for example up to 7,500 psi (51675 kPa) so that the mud is forced out through a bit at the lower end of the drill pipe and returned to the surface, carrying rock cuttings from the well. In other settings, the relief valve of the present invention may be used with even higher pump pressures such as 15,000 psi (103,350 kPa) for fracking or cementing.

In normal operation, with the line, or system pressure at a pressure less than the predetermined value at which it is desired to relieve system pressure, the piston 16 is at its open position. At this position, fluid will flow from the inlet port 12, and out discharge conduit 14, until there are sufficiently reduced pressure readings with pressure probe 46. Once the pressure reaches a desired lower value, the valve can be closed in a controlled manner to restore the system to a status quo operation. However, when the line pressure exceeds the predetermined value, typically as an almost instantaneous pressure spike resulting from line blockage, the actuator 30 will be signaled to move the piston rod 36 causing the reset valve 10 to open. In certain conditions, the piston 16 will move very rapidly relieving a pressure spike. By using pre-determined computer control, for example, a 10% pressure spike would activate an opening of the valve until the pressure moves back to the pre-determined maximum. At that point, the valve would close thereby maintaining the pumping system without catastrophic failure or shut down which commonly occurs with passive relief valves.

Because the controlled movement of the piston 16 is actuated by the worm drive 32 there are no sudden uncontrolled openings of the valve. Rather, all movements of the piston are controlled based on pressure readings or other sensors to keep the system in operation and not damage any of the operative elements of the pumping system.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the claims.

What is claimed is:

1. A modulated reset relief valve comprising:
a body having an inlet port, an outlet port, and a piston;
said piston disposed in said body and moveable between a first position at which said piston is disposed in fluid flow-blocking relationship between said inlet port and said outlet port of the body thereby defining a pressurized chamber and a second position at which said piston is removed from said fluid flow-blocking position;
said piston having a stem that is operably engaged to an electrically controlled actuator;
a pressure sensor in fluid communication with said chamber for sensing pressure;
control of said piston through said sensed parameter for opening and closing said valve by activation of said actuator.

2. The modulated reset relief valve as claimed in claim 1 wherein said pressure sensor is electronically connected to a data storage system.

3. The modulated reset relief valve as claimed in claim 1 further comprising a worm drive.

4. The modulated reset relief valve as claimed in claim 1 wherein said pressure sensor is isolated in an oil filled chamber.

5. The modulated reset relief valve as claimed in claim 1 further comprising a computer controlled system for actuating said valve in response to sensed conditions.

6. The modulated reset relief valve as claimed in claim 1 wherein said valve is selectably openable upon receipt of pressure readings from said sensor.

7. The modulated reset relief valve as claimed in claim 6 wherein said actuator is remotely controlled.

8. The modulated reset relief valve as claimed in claim 8 wherein said piston is reversibly moveable in response to said sensed pressure.

9. A modulated reset relief valve comprising:
a body having an inlet port, an outlet port, and a piston;
said piston disposed in said body and moveable between a first position at which said piston is disposed in fluid flow-blocking relationship between said inlet port and said outlet port of the body thereby defining a pressurized chamber and a second position at which said piston is removed from said fluid flow-blocking position;
a pressure sensor in fluid communication with said chamber for sensing pressure that is electronically connected to worm drive;
said piston selectively moveable between said first position and said second position responsive to movement of said drive.

10. The modulated reset relief valve as claimed in claim 9 wherein said pressure sensor is electronically connected to a data storage system.

11. The modulated reset relief valve as claimed in claim 9 further comprising a computer controlled system for operating said valve in response to ambient conditions.

12. The modulated reset relief valve as claimed in claim 9 wherein actuator is operable on battery power.

13. The modulated reset relief valve as claimed in claim 9 further comprising a handheld controller.

14. The modulated relief valve as claimed in claim 9 wherein said data is continuously logged for a pre-determined period of time.

15. A modulated reset relief valve comprising:
a body having an inlet port, an outlet port, and a piston;
said piston disposed in said body and moveable between a first position at which said piston is disposed in fluid flow-blocking relationship between said inlet port and said outlet port of the body thereby defining a pressurized chamber and a second position at which said piston is removed from said fluid flow-blocking position;
said piston sealably engages a cylindrical member positioned above said inlet port in said body when in said first position, where said member has an inner diameter substantially equal to the outer diameter of said piston;
a transducer for sensing fluid pressure on said piston electrically connected to a computer for storing and analyzing pressure data from operation of the valve;
an electrically activatable worm drive operably connected to said piston for reversible movement of said piston.

16. The modulated reset relief valve as claimed in claim 15 wherein said piston is responsive to pressure readings to partially open said valve for a period of time and then automatically reset to said closed position.

17. The modulated reset relief valve as claimed in claim 15 wherein data is logged for pre-determined periods of time.

18. The modulated reset relief valve as claimed in claim 15 where said worm drive is manually controlled.

19. The modulated reset relief valve as claimed in claim 15 wherein said actuator is operable on battery power.

20. The modulated reset relief valve as claimed in claim 15 further comprising a handheld controller.
